(19) United States
(12) Patent Application Publication
(10) Pub. No.: US 2022/0006321 A1
(43) Pub. Date: Jan. 6, 2022

(54) COMPRESSED AIR ENERGY STORAGE AND POWER GENERATION APPARATUS AND COMPRESSED AIR ENERGY STORAGE AND POWER GENERATION METHOD

(71) Applicant: KABUSHIKI KAISHA KOBE SEIKO SHO (KOBE STEEL, LTD.), Hyogo (JP)

(72) Inventor: Yohei KUBO, Kobe-shi, Hyogo (JP)

(73) Assignee: KABUSHIKI KAISHA KOBE SEIKO SHO (KOBE STEEL, LTD.), Hyogo (JP)

(21) Appl. No.: 17/292,935

(22) PCT Filed: Nov. 20, 2019
(86) PCT No.: PCT/JP2019/045339

§ 371 Date: May 11, 2021

(30) Foreign Application Priority Data
Dec. 14, 2018 (JP) 2018-234826

(51) Int. Cl. H02J 15/00; F02C 6/16

(52) U.S. Cl. CPC H02J 15/006; F05D 2260/42; F02C 6/16

(57) ABSTRACT

A compressed air energy storage and power generation apparatus includes an electric motor, a compressor, an accumulator, an expander, a generator, and a controller, in which the compressor includes a first compressor of dynamic type and a second compressor of a positive displacement type, during charge of the apparatus, in a case where variation time of predicted variation power exceeds activation stop time of the first compressor, the controller supports a predicted variation power component by performing a unit number control of the first compressor and performing the unit number control and a rotation speed control of the second compressor, and in a case where the variation time of the predicted variation power is equal to or less than the activation stop time of the first compressor, the controller supports the predicted variation power component by performing the unit number control and the rotation speed control of the second compressor.

### TECHNICAL FIELD

The present invention relates to a compressed air energy storage and power generation apparatus and a compressed air energy storage and power generation method.

### BACKGROUND ART

Power generation using natural energy such as wind power generation and solar power generation depends on weather conditions, and thus its output may not be stable. For this reason, energy storage systems such as compressed air energy storage (CAES) systems are used to level the output.

A conventional compressed air energy storage (CAES) and power generation apparatus generally drives a compressor to store electrical energy as compressed air during off-peak hours in a power plant, and then drives an expander with the compressed air and activates a generator to generate electricity during high power demand hours.

Here, power generation using natural energy includes a long-period output variation and a short-period output variation. For example, in power generation using sunlight, a long-period output variation factor is, for example, a difference between daytime and nighttime, and a short-period output variation factor is, for example, the sun temporarily hidden in clouds. On the other hand, in power generation using wind power, the long-period output variation factor is, for example, power generation stop due to strong wind or no wind, and the short-period output variation is, for example, a variation of wind speed.

Further, Patent Document 1 discloses a compressed air energy storage and power generation apparatus capable of supporting both the long-period variation power and short-period variation power.

### PRIOR ART DOCUMENT

### Patent Document

Patent Document 1: JP 2016-34211 A

### SUMMARY OF THE INVENTION

Problems to be Solved by the Invention

Here, Patent Document 1 discloses that the compressed air energy storage and power generation apparatus uses different types of compressors and expanders in combination in order to support both the long-period and short-period variation power; however, it does not disclose how to control those compressors and expanders depending on predicted variation power.

Therefore, an object of the present invention is to provide a compressed air energy storage and power generation apparatus and a compressed air energy storage and power generation method capable of efficiently controlling operation of a compressor and an expander depending on predicted variation power.

### MEANS FOR SOLVING THE PROBLEMS

A first aspect of the present invention is a compressed air energy storage and power generation apparatus including an electric motor configured to be driven by input power, a compressor mechanically connected to the electric motor and configured to compress air, an accumulator in fluid communication with the compressor and configured to store compressed air compressed by the compressor, an expander in fluid communication with the accumulator and configured to be driven by the compressed air supplied from the accumulator, a generator mechanically connected to the expander, and a controller configured to control the compressed air energy storage and power generation apparatus, in which the compressor includes a first compressor of a dynamic type and a second compressor of a positive displacement type, the expander includes a first expander of a dynamic type and a second expander of a positive displacement type, during charge of the compressed air energy storage and power generation apparatus, in a case where variation time of predicted variation power exceeds activation stop time of the first compressor, the controller supports a predicted variation power component by performing a unit number control of the first compressor and performing the unit number control and a rotation speed control of the second compressor, and in a case where the variation time of the predicted variation power is equal to or less than the activation stop time of the first compressor, the controller supports the predicted variation power component by performing the unit number control and the rotation speed control of the second compressor, and/or during discharge of the compressed air energy storage and power generation apparatus, in a case where the variation time of the predicted variation power exceeds the activation stop time of the first expander, the controller supports the predicted variation power component by performing the unit number control of the first expander and performing the unit number control and the rotation speed control of the second expander, and in a case where the variation time of the predicted variation power is equal to or less than the activation stop time of the first expander, the controller supports the predicted variation power component by performing the unit number control and the rotation speed control of the second expander.

In the above configuration, control is changed depending on a magnitude of the variation time of the predicted variation power with respect to the activation stop time of the dynamic compressor and the dynamic expander, and thus the compressor and the expander that allow operation under efficient operation conditions can be selected. As a result, the operation of the compressor and the expander can be efficiently controlled.

The first aspect preferably further includes the following configuration.

(1) The accumulator includes a plurality of accumulators separated from each other, the plurality of accumulators is connected to the first compressor, the second compressor, the first expander, and the second expander and has internal pressures monitored.

(2) In the configuration (1), the controller performs control such that the first expander preferentially uses compressed air in the accumulator whose internal pressure exceeds a set pressure, and a second expander preferentially uses compressed air in the accumulator whose internal pressure is less than the set pressure.

(3) The first compressor is a turbo compressor, the first expander is a turbo expander, the second compressor is a screw compressor, and the second expander is a screw expander.

In the configuration (1), the plurality of accumulators is provided and the internal pressures of the accumulators are monitored, and thus the accumulators causing the compressor and the expander to be operated more efficiently can be selected.

The dynamic expander and the positive displacement expander have different optimum operating conditions. Thus, in the configuration (2), the accumulators preferentially used by each type of expander are selected depending on a magnitude of the internal pressure of the accumulators with respect to the set pressure. Therefore, the operation of the expanders can be controlled efficiently.

In the configuration (3), the operation can be easily controlled by adopting the turbo type for the dynamic compressor and expander and adopting the screw type for the positive displacement compressor and expander. Further, by adopting the screw type for the positive displacement type, it is possible to support compression and expansion of a relatively large capacity.

A second aspect of the present invention is a compressed air energy storage and power generation method of a compressed air energy storage and power generation apparatus including an electric motor configured to be driven by input power, a compressor mechanically connected to the electric motor and configured to compress air, an accumulator in fluid communication with the compressor and configured to store compressed air compressed by the compressor, an expander in fluid communication with the accumulator and configured to be driven by the compressed air supplied from the accumulator, and a generator mechanically connected to the expander, in which the compressor includes a first compressor of a dynamic type and a second compressor of a positive displacement type, and the expander includes a first expander of a dynamic type and a second expander of a positive displacement type, the method including, during charge of the compressed air energy storage and power generation apparatus, in a case where variation time of predicted variation power exceeds activation stop time of the first compressor, supporting a predicted variation power component by performing a unit number control of the first compressor and performing the unit number control and a rotation speed control of the second compressor, and in a case where the variation time of the predicted variation power is equal to or less than the activation stop time of the first compressor, supporting the predicted variation power component by performing the unit number control and the rotation speed control of the second compressor, and/or during discharge of the compressed air energy storage and power generation apparatus, in a case where the variation time of the predicted variation power exceeds the activation stop time of the first expander, supporting the predicted variation power component by performing the unit number control of the first expander and performing the unit number control and the rotation speed control of the second expander, and in a case where the variation time of the predicted variation power is equal to or less than the activation stop time of the first expander, supporting the predicted variation power component by performing the unit number control and the rotation speed control of the second expander.

In the above configuration, the control changes depending on a magnitude of the variation time of the predicted variation power with respect to the activation stop time of the dynamic compressor and the dynamic expander, and thus the operation of the compressor and the expander can be efficiently controlled.

### EFFECT OF THE INVENTION

According to the present invention, it is possible to provide a compressed air energy storage and power generation apparatus and a compressed air energy storage and power generation method capable of efficiently controlling the operation of the compressor and the expander depending on the predicted variation power.

### BRIEF DESCRIPTION OF THE DRAWINGS

FIG. 1 is a schematic configuration diagram of a compressed air energy storage and power generation apparatus according to an embodiment of the present invention;

FIG. 2 is a flowchart of an overall flow of control of a controller;

FIG. 3 is a flowchart of a long-period variation operation at a charge command;

FIG. 4 is a graph of charged power with respect to time in a situation of FIG. 3;

FIG. 5 is a flowchart of a short-period variation operation at the charge command;

FIG. 6 is a graph of charged power with respect to time in a situation of FIG. 5;

FIG. 7 is a flowchart of the long-period variation operation at a discharge command;

FIG. 8 is a graph of discharged power with respect to time in a situation of FIG. 7;

FIG. 9 is a flowchart of the short-period variation operation at the discharge command;

FIG. 10 is a graph of discharged power with respect to time in a situation of FIG. 9; and

FIG. 11 is a flowchart for selection of accumulators 6a and 6b at the discharge command.

### MODE FOR CARRYING OUT THE INVENTION

Hereinafter, an embodiment of the present invention will be described with reference to the accompanying drawings.

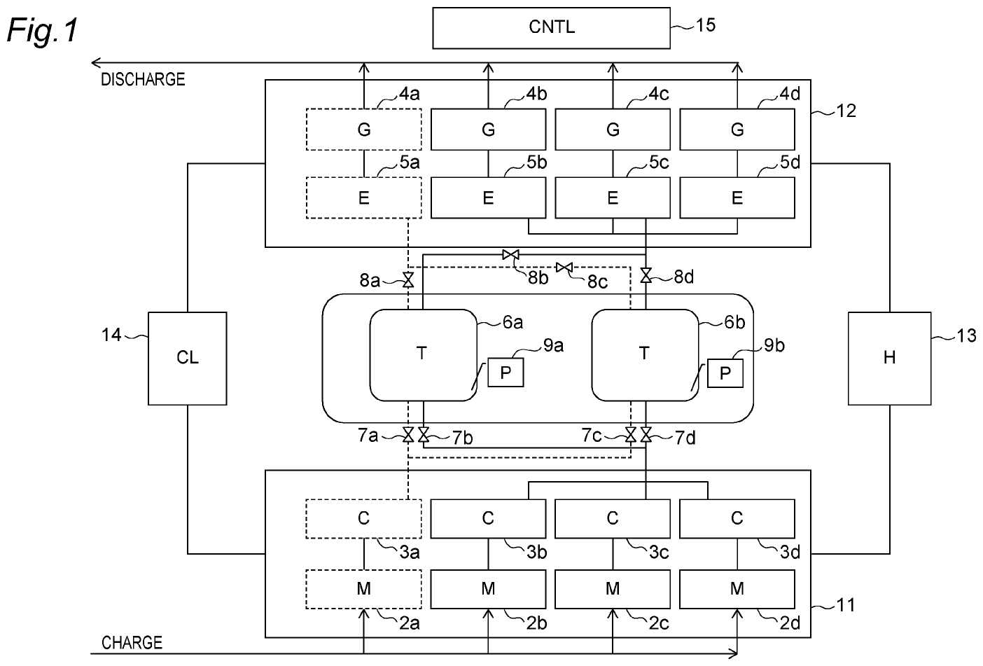

FIG. 1 is a schematic configuration diagram of a compressed air energy storage (CAES) and power generation apparatus 10 according to the embodiment of the present invention. The CAES and power generation apparatus 10 is for leveling output variations when generating power using natural energy and for generating an output depending on variations in power demand.

As shown in FIG. 1, the CAES and power generation apparatus 10 includes motors (electric motors) 2a to 2d and compressors 3a to 3d as a charge unit 11, and generators 4a to 4d and expanders 5a to 5d as a discharge unit 12. The CAES and power generation apparatus 10 further includes accumulators 6a and 6b storing compressed air, injection-side valves 7a to 7d provided in an air supply path between the accumulators 6a and 6b and the compressors 3a to 3d, and discharge-side valves 8a to 8d provided in an air supply path between the accumulators 6a and 6b and the expanders 5a to 5d. Further, the CAES and power generation apparatus 10 includes a heat recovery and utilization unit 13 that recovers, into a heat medium, heat generated by the compressors and returns the heat to the compressed air before being expanded by the expanders, a cooling unit 14 that cools a charge unit 11 and a discharge unit 12, and a controller 15 that controls the CAES and power generation apparatus 10.

Power generated by the power generation apparatus using natural energy (located on a charging side in FIG. 1 (not shown)) is supplied to the motors 2a to 2d electrically connected in parallel to each other through a charging line. This power drives the motors 2a to 2d. The motors 2a to 2d are mechanically connected to the compressors 3a to 3d, respectively. The compressors 3a to 3d operate by driving the motors 2a to 2d, respectively. The compressors 3a to 3d compress sucked air and pump the air to the accumulators 6a and 6b. As a result, energy can be stored in the accumulators 6a and 6b as compressed air. Note that the power generation apparatus using natural energy can be any power generation apparatus using energy that is constantly (or repetitively) replenished by natural force such as wind power, solar power, solar heat, wave power or tidal power, running water or tide, or geothermal heat. Further, as the accumulators 6a and 6b, accumulator tanks or, if capacity is relatively large, rock salt layer cavities, tunnels in closed mines, underground cavities such as sewage pipes and vertical holes, bag-shaped containers submerged in water, or the like can be used.

With the injection-side valves 7a to 7d provided in the air supply path between the compressors 3a to 3d and the accumulators 6a and 6b, where the compressed air from the compressors 3a to 3d is to be supplied to is changed between the accumulators 6a and 6b.

The compressed air accumulated in the accumulators 6a and 6b is supplied to the expanders 5a to 5d. The expanders 5a to 5d are driven by this compressed air. With the discharge-side valves 8a to 8d provided in the air supply path between the accumulators 6a and 6b and the expanders 5a to 5d, where the compressed air from the accumulators 6a and 6b is to be supplied to is among the expanders 5a to 5d.

The expanders 5a to 5d are electrically connected to each other in parallel and are mechanically connected to the generators 4a to 4d, respectively. The generators 4a to 4d operate by driving the expanders 5a to 5d to generate power. The generated power is supplied to a supply destination through a discharge line.

The accumulators 6a and 6b are provided with pressure sensors 9a and 9b that measure pressure in the accumulators 6a and 6b, respectively. The controller 15 controls opening and closing of the injection-side valves 7a to 7d and the discharge-side valves 8a to 8d on the basis of a charge-discharge command and measured values of the pressure sensors 9a and 9b.

In the present embodiment, the compressor 3a is a positive displacement compressor, and the compressors 3b to 3d are dynamic compressors. Specifically, the positive displacement compressor 3a is a screw compressor, and the dynamic compressors 3b to 3d are turbo compressors. Further, the expander 5a is a positive displacement expander, and the expanders 5b to 5d are dynamic expanders. Specifically, the positive displacement expander 5a is a screw expander, and dynamic expanders 5b to 5d are turbo expanders. Note that efficiency of a positive displacement type is less likely to decrease even with a smaller capacity (low rotation speed) than efficiency of a dynamic type. Thus, power can be generated stably even in a case where the compressed air stored in the accumulators 6a and 6b is small, and a control range can be expanded. Further, a screw type is suitable for a positive displacement type (a scroll type, a rotary type, or the like) with a relatively large capacity.

Next, control of the CAES and power generation apparatus 10 by the controller 15 will be described.

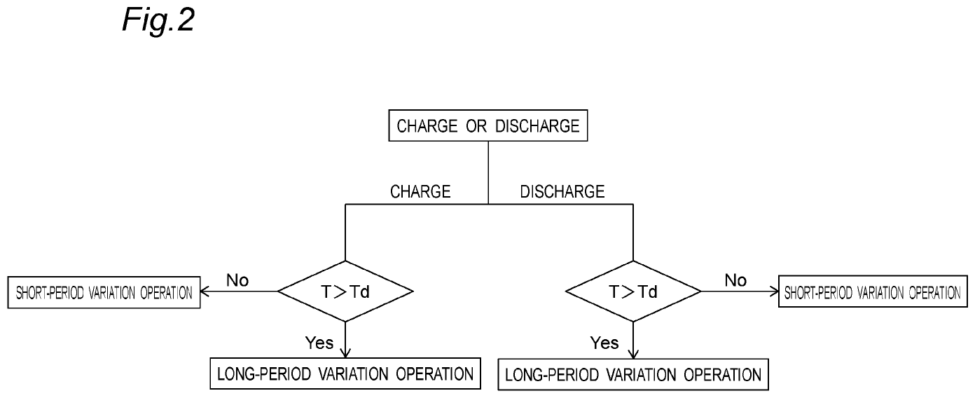

FIG. 2 is a flowchart of an overall flow of control of the controller 15. As shown in FIG. 2, on the basis of the charge or discharge command from a system, the controller 15 determines whether to perform a long-period variation operation or a short-period variation operation. Specifically, upon receipt of a charge command, the controller 15 determines whether variation time T of predicted variation power exceeds activation stop time Td of the turbo compressors 3b to 3d. Then, the controller 15 performs the long-period variation operation if the variation time T exceeds the activation stop time Td, and the controller 15 performs the short-period variation operation if the variation time T does not exceed the activation stop time Td. Similarly, upon receipt of a discharge command, the controller 15 determines whether the variation time T of the predicted variation power exceeds the activation stop time Td of the turbo expanders 5b to 5d. Then, the controller 15 performs the long-period variation operation if the variation time T exceeds the activation stop time Td, and the controller 15 performs the short-period variation operation if the variation time T does not exceed the activation stop time Td. The predicted variation power corresponds to a variation part of the power when the controller 15 predicts the power at the charge or discharge command from the system.

Time of Charge of CAES and Power Generation Apparatus 10

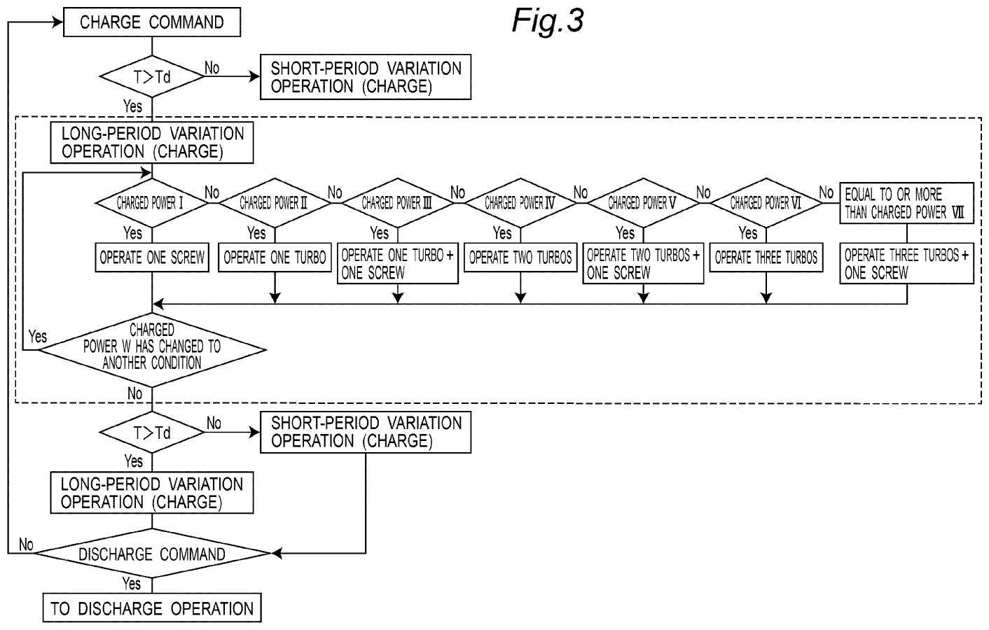

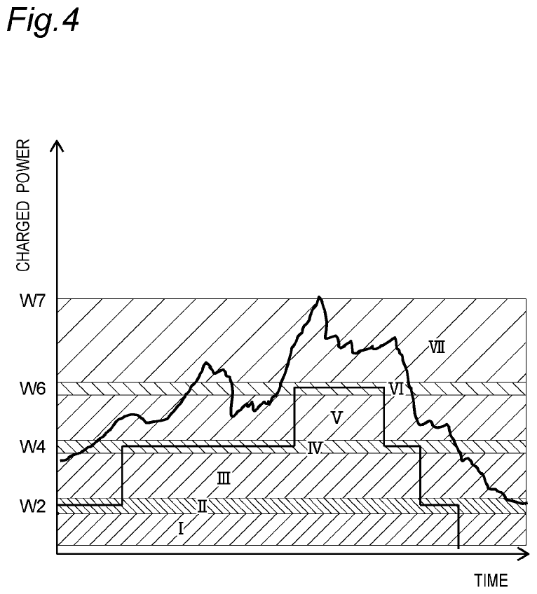

FIG. 3 is a flowchart of the long-period variation operation at the charge command, and FIG. 4 is a graph of charged power with respect to time in a situation of FIG. 3. As shown in FIGS. 3 and 4, in the long-period variation operation at the charge command, the controller 15 supports a predicted variation power component by performing the unit number control of the turbo compressors 3b to 3d and the unit number control and a rotation speed control of the screw compressor 3a. That is, because the variation time T of the predicted variation power exceeds the activation stop time Td of the turbo compressors 3b to 3d, a large capacity part is supported by the turbo compressors 3b to 3d, and a variation part that cannot be supported by the screw compressor 3a is supported by the turbo compressors 3b to 3d. Here, the predicted variation power component is a variation part of a predicted value of the charged power.

Specifically, in a case where charged power W is in a region I (0<W<W1 (W1 is in an operation range of the screw compressor)), one screw compressor is activated, and the rotation speed control of the screw compressor is performed. In a case where the charged power W is in a region II (W1<W<W2 (W2 is rated power of the turbo compressor)), one turbo compressor is activated at a rated value. In a case where the charged power W is in a region III (W2<W<W3 (W3−W2 is in the operation range of the screw compressor)), one turbo compressor is activated at the rated value, one screw compressor is additionally activated, and the rotation speed control of the screw compressor is performed. In a case where the charged power W is in a region IV (W3<W<W4 (W4 is the rated power of two turbo compressors)), two turbo compressors are activated at the rated value. In a case where the charged power W is in a region V (W4<W<W5 (W5−W4 is in the operation range of the screw compressor)), two turbo compressors are activated at the rated value, one screw compressor is additionally activated, and the rotation speed control of the screw compressor is performed. In a case where the charged power W is in a region VI (W5<W<W6 (W6 is the rated power of three turbo compressors)), three turbo compressors are activated at the rated value. In a case where the charged power W is in a region VII (W6<W<W7 (W7−W6 is in the operation range of the screw compressor)), three turbo compressors are activated at the rated value, one screw compressor is additionally activated, and the rotation speed control of the screw compressor is performed. In the operation of the turbo compressor, the controller 15 predicts a power change and controls so as not to start or stop quickly. Further, even during the long-period variation operation, the operation is changed to the short-period variation operation if the variation time T of the predicted variation power does not exceed the activation stop time Td of the turbo compressor in the next prediction. Although the case where the charged power W is in the regions I to VII has been described here as an example, the number of regions is an example and is not limited thereto. Further, a rated capacity and the number of screw compressors and the rated capacity and the number of turbo compressors are also examples, and are not limited thereto.

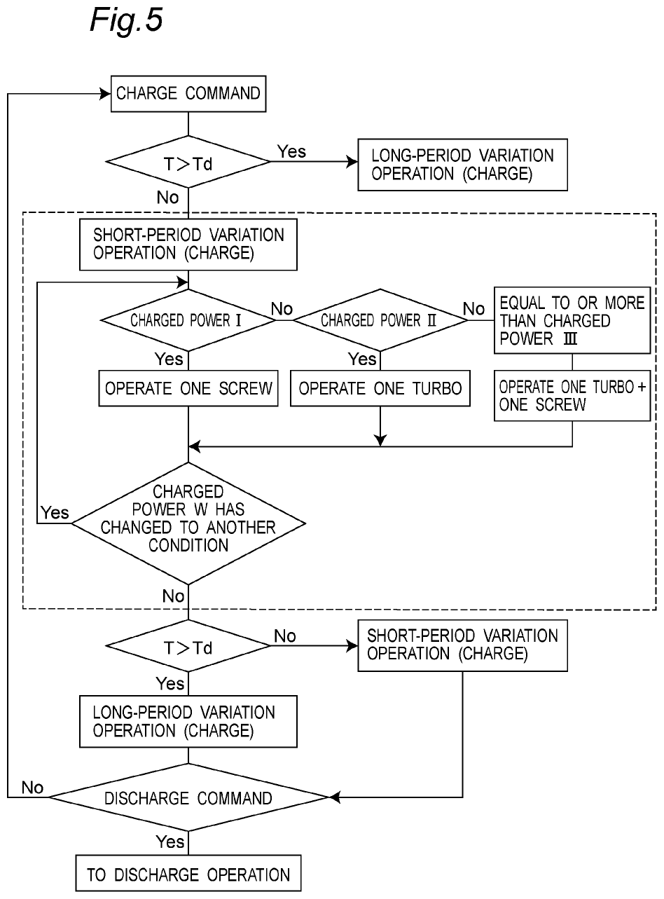

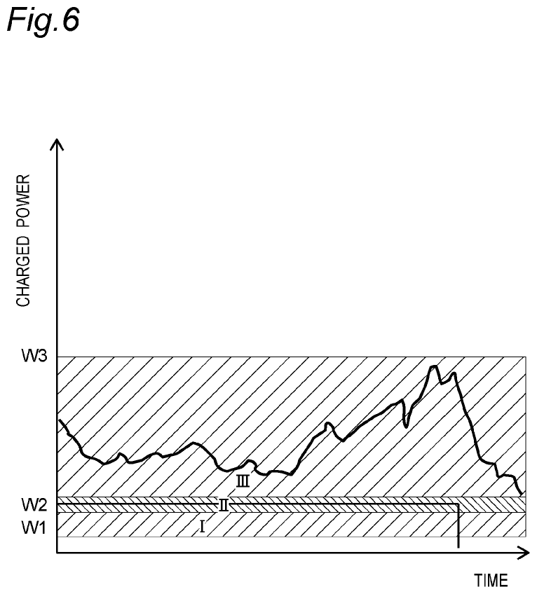

FIG. 5 is a flowchart of the short-period variation operation at the charge command, and FIG. 6 is a graph of the charged power with respect to time in a situation of FIG. 5. As shown in FIGS. 5 and 6, in the short-period variation operation at the charge command, the controller 15 supports the predicted variation power component by performing the unit number control of the screw compressor 3a and the rotation speed control of the screw compressor 3a. That is, the variation time T of the predicted variation power is less than the activation stop time Td of the turbo compressors 3b to 3d, and thus the support by the turbo compressors 3b to 3d would not be in time. Therefore, the variation part is supported by the screw compressor 3a.

Specifically, in a case where charged power W is in a region I (0<W<W1 (W1 is in an operation range of the screw compressor)), one screw compressor is activated, and the rotation speed control of the screw compressor is performed. In a case where the charged power W is in a region II (W1<W<W2 (W2 is rated power of the turbo compressor)), one turbo compressor is activated at a rated value. In a case where the charged power W is in a region III (W2<W<W3 (W3−W2 is in the operation range of the screw compressor)), one turbo compressor is activated at the rated value, one screw compressor is additionally activated, and the rotation speed control of the screw compressor is performed. Note that even during the short-period variation operation, the operation is changed to the long-period variation operation if the variation time T of the predicted variation power exceeds the activation stop time Td of the turbo compressor in the next prediction. Although the case where the charged power W is in the regions I to III has been described here as an example, the number of regions is an example and is not limited thereto. Further, the rated power and the number of screw compressors and the rated power and the number of turbo compressors are also examples, and are not limited thereto.

Regarding an opening and closing state of the injection-side valves 7a to 7d at the charge command, in a case where the turbo compressors 3b to 3d and the screw compressor 3a are activated, the injection-side valves 7a and 7d are opened and the injection-side valves 7b and 7c are closed. In a case where a plurality of the turbo compressors 3b to 3d is activated, the injection-side valves 7a, 7c, and 7d are opened and the injection-side valve 7b is closed. In a case where only the screw compressor 3a is activated, the injection-side valve 7a is opened and the injection-side valves 7b to 7d are closed. At the charge command, the discharge-side valves 8a to 8d are closed.

Time of Discharge of CAES and Power Generation Apparatus 10

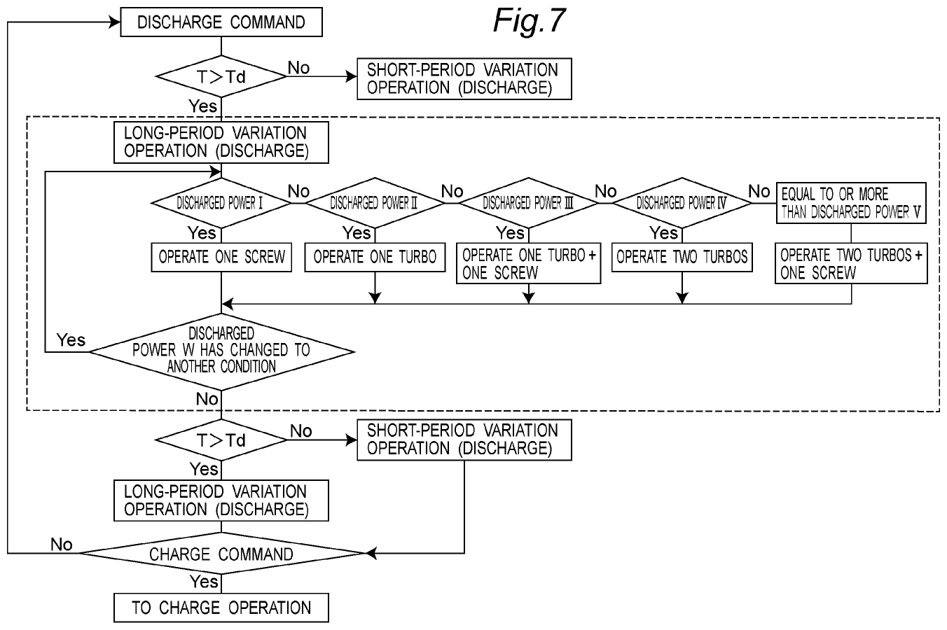

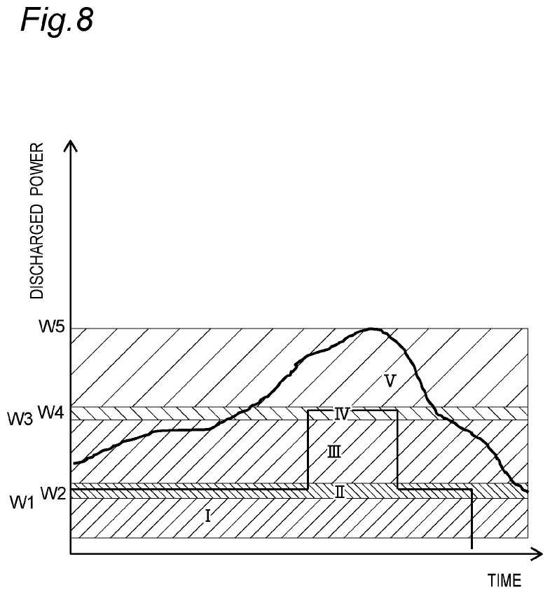

FIG. 7 is a flowchart of the long-period variation operation at the discharge command, and FIG. 8 is a graph of discharged power (demand power) with respect to time in a situation of FIG. 7. As shown in FIGS. 7 and 8, in the long-period variation operation at the discharge command, the controller 15 supports a predicted variation power component by performing the unit number control of the turbo expanders 5b to 5d and the unit number control and the rotation speed control of the screw expander. That is, because the variation time T of the predicted variation power exceeds the activation stop time Td of the turbo expanders, a large capacity part is supported by the turbo expanders, and a variation part that cannot be supported by the screw expanders are supported by the turbo expanders. Here, the predicted variation power component is a variation part of a predicted value of the discharged power.

Specifically, in a case where discharged power W is in a region I (0<W<W1 (W1 is in an operation range of the screw expander)), one screw expander is activated, and the rotation speed control of the screw expander is performed. In a case where the discharged power W is in a region II (W1<W<W2 (W2 is rated power of the turbo expander)), one turbo expander is activated at a rated value. In a case where the discharged power W is in a region III (W2<W<W3 (W3−W2 is in the operation range of the screw expander)), one turbo expander is activated at the rated value, one screw expander is additionally activated, and the rotation speed control of the screw expander is performed. In a case where the charged power W is in a region IV (W3<W<W4 (W4 is rated power of two turbo expanders)), two turbo expander is activated at a rated value. In a case where the charged power W is in a region V (W4<W<W5 (W5−W4 is in the operation range of the screw expander)), two turbo expanders are activated at the rated value, one screw expander is additionally activated, and the rotation speed control of the screw expander is performed. In the operation of the turbo expander, the controller 15 predicts a power change and controls so as not to start or stop quickly. Further, even during the long-period variation operation, the operation is changed to the short-period variation operation if the variation time T of the predicted variation power does not exceed the activation stop time Td of the turbo expander in the next prediction. Here, the case where the discharged power W is in the regions I to V has been described as an example, but the number of regions is an example and is not limited thereto. Further, the rated power and the number of screw expanders and the rated power and the number of turbo expanders are also examples, and are not limited thereto.

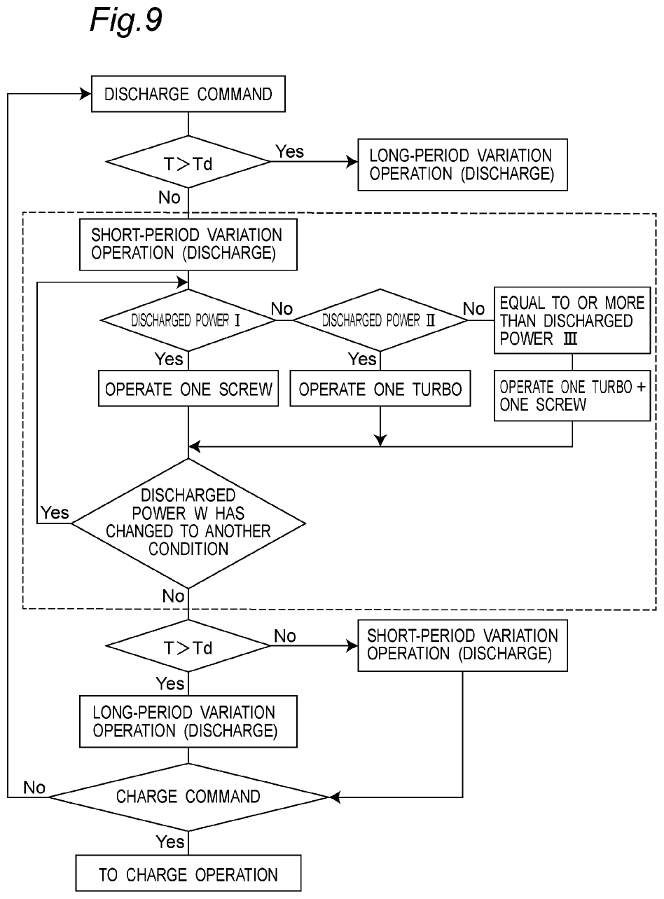

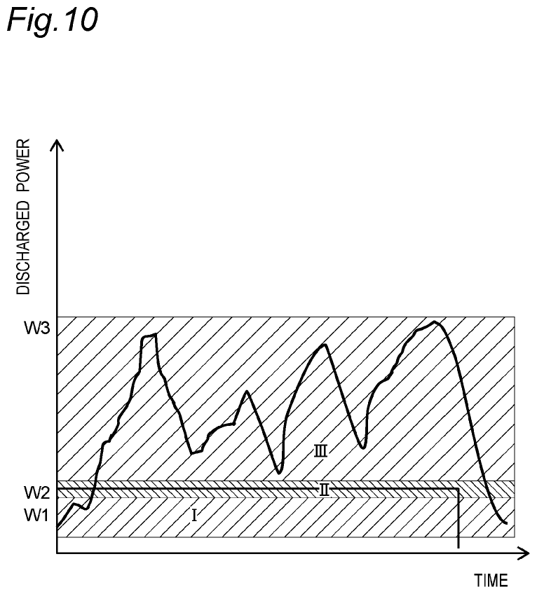

FIG. 9 is a flowchart of the short-period variation operation at the discharge command, and FIG. 10 is a graph of the discharged power (demand power) with respect to time in a situation of FIG. 9. As shown in FIGS. 9 and 10, in the short-period variation operation at the discharge command, the controller 15 supports the predicted variation power component by performing the unit number control of the screw expander and the rotation speed control of the screw expander. That is, the variation time T of the predicted variation power is less than the activation stop time Td of the turbo expanders, and thus the support by the turbo expanders would not be in time. Therefore, the variation part is supported by the screw expander.

Specifically, in a case where discharged power W is in a region I (0<W<W1 (W1 is in an operation range of the screw expander)), one screw expander is activated, and the rotation speed control of the screw expander is performed. In a case where the discharged power W is in a region II (W1<W<W2 (W2 is rated power of the turbo expander)), one turbo expander is activated at a rated value. In a case where the discharged power W is in a region III (W2<W<W3 (W3−W2 is in the operation range of the screw compressor)), one turbo compressor is activated at the rated value, one screw compressor is additionally activated, and the rotation speed control of the screw compressor is performed. Note that even during the short-period variation operation, the operation is changed to the long-period variation operation if the variation time T of the predicted variation power exceeds the activation stop time Td of the turbo expander in the next prediction. Although the case where the discharged power W is in the regions I to III has been described here as an example, the number of regions is an example and is not limited thereto. Further, the rated capacity and the number of screw expanders and the rated capacity and the number of turbo expanders are also examples, and are not limited thereto.

Regarding the opening and closing state of the discharge-side valves 8a to 8d at the discharge command, in a case where the turbo expander and the screw expander are activated, the discharge-side valves 8a and 8d are opened and the discharge-side valves 8b and 8c are closed. In a case where a plurality of the turbo expanders is activated, the discharge-side valves 8a, 8c, and 8d are opened and the discharge-side valve 8b is closed. In a case where only the screw expander is activated, the discharge-side valve 8a is opened and the discharge-side valves 8b to 8d are closed. At the discharge command, the injection-side valves 7a to 7d are closed.

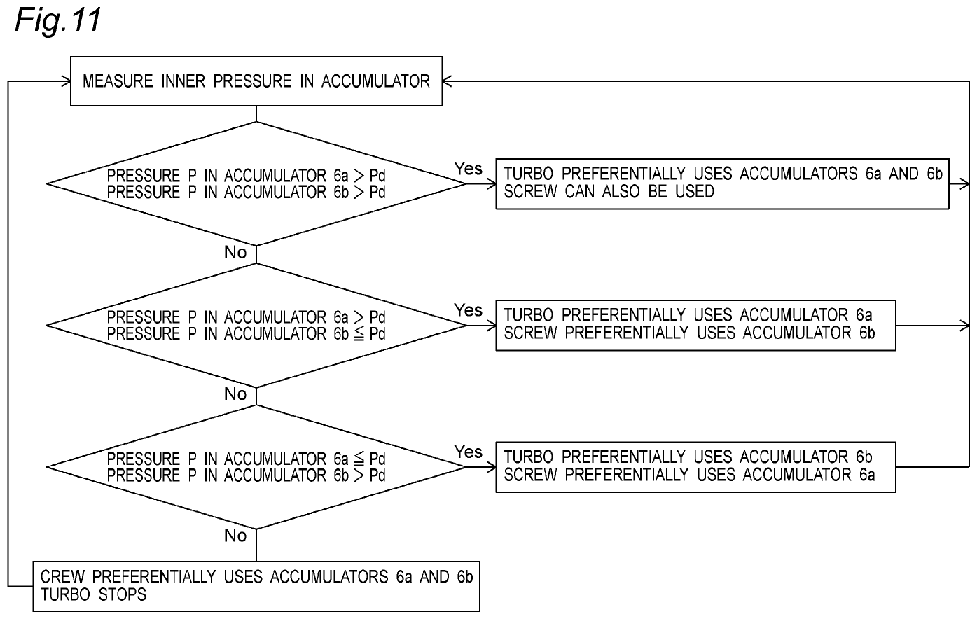

FIG. 11 is a flowchart of selection of the accumulators 6a and 6b at the discharge command. The pressure sensor 9a measures the pressure in the accumulator 6a, and the pressure sensor 9b measures the pressure in the accumulator 6b. As shown in FIG. 11, the controller 15 performs control such that a first expander preferentially uses the compressed air in the accumulator whose internal pressure P exceeds a set pressure Pd, and a second expander preferentially uses the compressed air in the accumulator whose internal pressure P is less than the set pressure Pd.

Specifically, the controller 15 performs control such that if the internal pressure P of the accumulator 6a exceeds the set pressure Pd and the internal pressure P of the accumulator 6b also exceeds the set pressure Pd, the turbo expander preferentially uses the accumulators 6a and 6b and the screw expander also uses the accumulators 6a and 6b. Further, the controller 15 performs control such that if the internal pressure P of the accumulator 6a exceeds the set pressure Pd and the internal pressure P of the accumulator 6b is equal to or less than the set pressure Pd, the turbo expander preferentially uses the accumulator 6ab and the screw expander preferentially uses the accumulator 6b.

The controller 15 performs control such that if the internal pressure P of the accumulator 6a is equal to or less than the set pressure Pd and the internal pressure P of the accumulator 6b exceeds the set pressure Pd, the turbo expander preferentially uses the accumulators 6b and the screw expander preferentially uses the accumulator 6a. Further, the controller 15 performs control such that if the internal pressure P of the accumulator 6a is equal to or less than the set pressure Pd and the internal pressure P of the accumulator 6b is also equal to or less than the set pressure Pd, the screw expander preferentially uses the accumulators 6a and 6b and the turbo expander stops.

A CAES and power generation apparatus 2 having the above configuration can exhibit the following effects.

(1) During charge of the CAES and power generation apparatus 10, if the variation time T of the predicted variation power exceeds the activation stop time Td of the turbo compressors 3b to 3d, the controller 15 performs control such that the predicted variation power component is supported by performing the unit number control of the turbo compressors 3b to 3d and performing the unit number control and the rotation speed control of the screw compressor 3a. If the variation time T of the predicted variation power is equal to or less than the activation stop time Td of the turbo compressors 3b to 3d, the controller performs control such that the predicted variation power component is supported by performing the unit number control and the rotation speed control of the screw compressor 3a. Further, during discharge of the CAES and power generation apparatus 10, if the variation time T of the predicted variation power exceeds the activation stop time Td of the turbo expanders 5b to 5d, the controller 15 performs control such that the predicted variation power component is supported by performing the unit number control of the turbo expanders 5b to 5d and performing the unit number control and the rotation speed control of the screw expander 5a. If the variation time T of the predicted variation power is equal to or less than the activation stop time Td of the turbo expanders 5b to 5d, the controller performs control such that the predicted variation power component is supported by performing the unit number control and the rotation speed control of the screw expander 5a. That is, the controller 15 changes control depending on a magnitude of the variation time of the predicted variation power with respect to the activation stop time of the dynamic compressors 3b to 3d and the dynamic expanders 5b to 5d, and thus the compressors 3a to 3d and the expanders 5a to 5d that allow operation under efficient operation conditions can be selected. As a result, the operation of the compressors 3a to 3d and the expanders 5a to 5d can be efficiently controlled. Then, operation efficiency of the CAES and power generation apparatus 10 can be improved.

(2) The plurality of accumulators 6a and 6b is provided and the internal pressures of the accumulators 6a and 6b are monitored by the pressure sensors 9a and 9b, and thus the accumulators 6a and 6b causing the compressor and the expander to be operated more efficiently can be selected.

(3) The dynamic expander and the positive displacement expander have different optimum operating conditions, the accumulators 6a and 6b preferentially used by each type of expander are selected depending on a magnitude of the internal pressure of the accumulators 6a and 6b with respect to the set pressure. Therefore, the operation of the expander can be controlled efficiently. Specifically, the compressed air is preferentially supplied from the accumulator whose internal pressure P exceeds the set pressure Pd to the dynamic expander, and the compressed air is preferentially supplied from the accumulator whose internal pressure P is equal to or less than the set pressure Pd to the positive displacement expander.

(4) The operation can be easily controlled by adopting the turbo type for the dynamic compressor and expander and adopting the screw type for the positive displacement compressor and expander. Further, by adopting the screw type for the positive displacement type, it is possible to support compression and expansion of a relatively large capacity as compared with other positive displacement types such as the scroll type and the rotary type.

In the above embodiment, a CAES and power generation apparatus including one screw compressor, three turbo compressors, one screw expander, and three turbo expanders has been described as an example. However, it is sufficient that one or more compressors of each type and one or more expanders of each type are included. Further, although it has been described that the compressors and the expanders of the same type have the same performance, the compressors and the expanders of the same type may have different performance.

In the above embodiment, the activation stop times Td of the turbo compressors 3b to 3d and the activation stop times Td of the turbo expanders 5b to 5d are described as being the same, but the activation stop time may be different between the turbo compressors and the turbo expanders. Further, the activation stop time may be different between the same compressors and expanders. In that case, determination is made by the activation stop time of the compressor or expander to be activated or stopped.

In the above embodiment, an example is described in which the accumulator includes two accumulators 6a and 6b; however, the number of accumulators only has to be plural, and the accumulator may include three or more accumulators. Further, the capacities of the accumulators may be the same or different.

The present invention is not limited to the configuration described in the above embodiment, and can include various modifications that can be considered by those skilled in the art without departing from the contents described in the claims.

### DESCRIPTION OF SYMBOLS

2a, 2b, 2c, 2d: Motor, 3a: Second compressor (screw compressor), 3b: First compressor (turbo compressor), 3c: First compressor (turbo compressor), 3d: First compressor (turbo compressor), 4a; 4b; 4c; 4d: Generator, 5a: Second expander (screw expander), 5b: First expander (turbo expander), 5c: First expander (turbo expander), 5d: First expander (turbo expander), 6a: Accumulator, 6b: Accumulator, 7a; 7b; 7c; 7d: Injection-side valve, 8a; 8b; 8c; 8d: Discharge-side valve, 9a: Pressure sensor, 9b: Pressure sensor, 10: CAES and power generation apparatus, 11: Charge unit, 12: Discharge unit, 13: Heat recovery and utilization unit, 14: Cooling unit, 15: Controller.

1. A compressed air energy storage and power generation apparatus comprising:
an electric motor configured to be driven by input power;
a compressor mechanically connected to the electric motor and configured to compress air;
an accumulator in fluid communication with the compressor and configured to store compressed air compressed by the compressor;
an expander in fluid communication with the accumulator and configured to be driven by the compressed air supplied from the accumulator;
a generator mechanically connected to the expander; and
a controller configured to control the compressed air energy storage and power generation apparatus,
wherein
the compressor includes a first compressor of a dynamic type and a second compressor of a positive displacement type,
the expander includes a first expander of a dynamic type and a second expander of a positive displacement type,
during charge of the compressed air energy storage and power generation apparatus, in a case where variation time of predicted variation power exceeds activation stop time of the first compressor, the controller supports a predicted variation power component by performing a unit number control of the first compressor and performing the unit number control and a rotation speed control of the second compressor, and in a case where the variation time of the predicted variation power is equal to or less than the activation stop time of the first compressor, the controller supports the predicted variation power component by performing the unit number control and the rotation speed control of the second compressor, and/or
during discharge of the compressed air energy storage and power generation apparatus, in a case where the variation time of the predicted variation power exceeds the activation stop time of the first expander, the controller supports the predicted variation power component by performing the unit number control of the first expander and performing the unit number control and the rotation speed control of the second expander, and in a case where the variation time of the predicted variation power is equal to or less than the activation stop time of the first expander, the controller supports the predicted variation power component by performing the unit number control and the rotation speed control of the second expander.

2. The compressed air energy storage and power generation apparatus according to claim 1, wherein
the accumulator includes a plurality of accumulators separated from each other,
the plurality of accumulators is connected to the first compressor, the second compressor, the first expander, and the second expander and has internal pressures monitored.

3. The compressed air energy storage and power generation apparatus according to claim 2, wherein the controller performs control such that the first expander preferentially uses compressed air in the accumulator whose internal pressure exceeds a set pressure, and a second expander preferentially uses compressed air in the accumulator whose internal pressure is less than the set pressure.

4. The compressed air energy storage and power generation apparatus according to claim 1, wherein
the first compressor is a turbo compressor,
the first expander is a turbo expander,
the second compressor is a screw compressor, and
the second expander is a screw expander.

5. A compressed air energy storage and power generation method of a compressed air energy storage and power generation apparatus including
an electric motor configured to be driven by input power,
a compressor mechanically connected to the electric motor and configured to compress air,
an accumulator in fluid communication with the compressor and configured to store compressed air compressed by the compressor,
an expander in fluid communication with the accumulator and configured to be driven by the compressed air supplied from the accumulator, and
a generator mechanically connected to the expander,
wherein
the compressor includes a first compressor of a dynamic type and a second compressor of a positive displacement type, and
the expander includes a first expander of a dynamic type and a second expander of a positive displacement type, the method comprising:
during charge of the compressed air energy storage and power generation apparatus, in a case where variation time of predicted variation power exceeds activation stop time of the first compressor, supporting a predicted variation power component by performing a unit number control of the first compressor and performing the unit number control and a rotation speed control of the second compressor, and in a case where the variation time of the predicted variation power is equal to or less than the activation stop time of the first compressor, supporting the predicted variation power component by performing the unit number control and the rotation speed control of the second compressor; and/or
during discharge of the compressed air energy storage and power generation apparatus, in a case where the variation time of the predicted variation power exceeds the activation stop time of the first expander, supporting the predicted variation power component by performing the unit number control of the first expander and performing the unit number control and the rotation speed control of the second expander, and in a case where the variation time of the predicted variation power is equal to or less than the activation stop time of the first expander, supporting the predicted variation power component by performing the unit number control and the rotation speed control of the second expander.

6. The compressed air energy storage and power generation apparatus according to claim 2, wherein
the first compressor is a turbo compressor,
the first expander is a turbo expander,
the second compressor is a screw compressor, and
the second expander is a screw expander.
